(19) United States
(12) Patent Application Publication
(10) Pub. No.: US 2010/0080288 A1
(43) Pub. Date: Apr. 1, 2010

(54) VIDEO COMPRESSION CODING METHOD AND APPARATUS

(75) Inventors: Masaki HAMAMOTO, Kokubunji (JP); Takafumi Yuasa, Musashino (JP); Muneaki Yamaguchi, Inagi (JP); Masatoshi Kondo, Kodaira (JP)

Correspondence Address: MCDERMOTT WILL & EMERY LLP, 600 13TH STREET, N.W., WASHINGTON, DC, 20005-3096, US

(73) Assignee: Hitachi Kokusai Electric Inc.

(21) Appl. No.: 12/479,080

(22) Filed: Jun. 5, 2009

(30) Foreign Application Priority Data
Sep. 29, 2008 (JP) 2008-249984

(51) Int. Cl. H04N 7/26; H04N 7/32

(52) U.S. Cl. 375/240.03; 375/240.12; 375/E07.243; 375/E07.139

(57) ABSTRACT

A first delay memory is input with an input image frame output from a ME (motion estimation) processor, and delays output to a first adder for carrying out a prediction residual generation process a predetermined time period. A second delay memory is input with an inter-prediction luminance image frame, and delays output to a prediction selection circuit a predetermined time period. A third delay memory is input with motion vector information output from the ME processor, and delays output of the motion vector information to an inter-prediction chrominance image creation processor a predetermined time period.

### CROSS-REFERENCE TO PRIOR APPLICATION

This application relates to and claims priority from Japanese Patent Application No. 2008-249984, filed on Sep. 29, 2008 the entire disclosure of which is incorporated herein by reference.

### BACKGROUND

The present invention generally relates to a video compression coding method and apparatus, which compress the amount of information in an input image frame by carrying out a predetermined coding process on the above-mentioned image frame.

In the field of video data compression technology, a related-art proposal that has as an object the provision of an apparatus, which is able to generate compressed video data having a suitable amount of data, and which is able to shorten the time required for video data compression processing is known. In this proposal, respective processes are executed, such as preprocessing for compression-coding the video data; the generation of flatness and intra-AC (flatness and intra-AC are parameters denoting the degree of difficulty with respect to a picture pattern to be compressed into an I-picture); the calculation of the amount of prediction error for video motion estimation (ME residual); and delay processing for each picture of the input video data. In this proposal, respective processes are also executed subsequent to the above-mentioned delay processing for each picture of the video data, such as approximation processing of actual degree of difficulty data denoting the degree of difficulty with respect to the pattern of each picture in accordance with the ME residual, flatness and intra-AC; the calculation of the target data amount of the compressed video data based on the actual degree of difficulty data subsequent to approximation processing; and compression coding processing such that the amount of data of the compressed video data constitutes the substantial target data amount (For example, refer to Japanese Patent Application Laid-open No. 2006-136010).

### SUMMARY

As disclosed in the above-mentioned Japanese Patent Application Laid-open No. 2006-136010, a video compression coding apparatus, which employs a method for controlling the amount of code characterized by determining a quantization parameter based on statistical data of a preset image region, is able to realize accurate code quantity control. Therefore, this code quantity control method may also be applied to a low-delay video compression coding apparatus (may also be described hereinafter as a “low-delay encoder”) by reducing the amount of statistical data, such as the activity used in predicting the amount of code, and SAD (the amount of error between an input image frame and a predictive image frame, that is, the sum of the absolute difference. SAD means the same hereinafter) to one picture's worth or less. When carrying out quantized control in accordance with generated code quantity prediction based on image statistical data as in the video compression coding apparatus related to Japanese Patent Application Laid-open No. 2006-136010, it is not possible to determine a quantization parameter until after all the statistical data in the set image region has been acquired. For this reason, a delay time equivalent to the above-mentioned image statistical data acquisition period must be provided between the detection of motion of the dynamic image inside the image frame and the quantizing of the frequency component in this image frame.

Accordingly, with the foregoing in mind, the following measures have been devised for the video compression coding apparatus related to Japanese Patent Application Laid-open No. 2006-136010. That is, a first delay memory has been interposed between a configuration that executes the dynamic image motion estimation process and a configuration that executes the process for generating a prediction residual, and a second delay memory for delaying the motion vector information generated in the above-mentioned motion estimation process has been interposed between the above-mentioned configuration that executes the motion estimation process and a configuration that executes a motion compensation process for the above-mentioned dynamic image. Consequently, it is possible to provide a delay time equivalent to the above-mentioned image statistical data acquisition period.

In the video compression coding apparatus related to Japanese Patent Application Laid-open No. 2006-136010, it is possible to set the latter stage side configuration of the first delay memory and the latter stage side configuration of the second delay memory to the same configuration as that of the decoding apparatus positioned on the latter stage side of the above-mentioned video compression coding apparatus. For this reason, circuit parts may be shared between the above-mentioned video compression coding apparatus and the above-mentioned coding apparatus, which is advantageous for shortening the period required for apparatus design. The motion vector information constitutes a small amount of data, and this is advantageous in that delaying the motion vector information makes it possible to curb increases in memory capacity in line with this delay, thereby curbing a rise in apparatus costs.

However, in MPEG-4/AVC (MPEG-4/Advanced Video Coding), which is the international standard subsequent to MPEG-2, a problem arises in that there is an increase in the amount of data that is transferred between the encoding LSI (of the video compression coding apparatus) and the external memory that is connected to this encoding LSI in accordance with delaying the motion vector information and carrying out the creation of a prediction image (an inter prediction image) by virtue of a motion compensation process after the elapse of a set delay time as in the video compression coding apparatus related to Japanese Patent Application Laid-open No. 2006-136010. The reason for this is because the inter-prediction image creation process of MPEG-4/AVC has characteristic features like those explained hereinbelow with respect to the inter prediction image creation process of MPEG-2.

That is, firstly, MPEG-4/AVC employs a six-tap filtering-based fractional pixel generation scheme, which is characterized by the need for large quantities of image data for prediction image frame generation. Secondly, MPEG-4/AVC inter prediction (prediction between image frames) (inter-prediction) is characterized in that since it is possible to carry out inter prediction by dividing one macroblock partitioned on an image frame into a maximum of 16 image blocks, a prediction image is generated for each of the maximum of 16 image blocks mentioned above. The problem that arises in accordance with the above-mentioned first characteristic feature is that the amount of data of a reference image (reference luminance image) related to the luminance required to create a luminance-related inter-prediction prediction image (inter-prediction luminance image) is enormous, working out to more than four times that of MPEG-2.

The problem that arises in accordance with the above-mentioned second characteristic feature is that, in a case where the reference image data required to create a prediction image (frame) is acquired from an external memory as in the video compression coding apparatus related to Japanese Patent Application Laid-open No. 2006-136010, access from this apparatus to the external memory involves acquiring small amounts of image data a plurality of times, resulting in the image data transfer efficiency between this apparatus and the external memory worsening considerably. Consequently, the problems that occur are an increase in the cost of securing bandwidth when transferring data between the video compression coding apparatus and the external memory, and an increase in the amount of power consumed in line with increases in the amount of data transferred from the external memory to the video compression coding apparatus. Moreover, since the bandwidth for transferring the data required to compress a dynamic image increases the higher the resolution of the image information to be input, the problems of increased costs and power consumption become even more serious in high-resolution applications for two-way data communications.

As described hereinabove, in the video compression coding apparatus related to Japanese Patent Application Laid-open No. 2006-136010, a reference luminance image for creating an inter-prediction luminance image is acquired from external memory after the elapse of the delay time for determining the quantization parameter. Consequently, the problem is that in a high-resolution application that uses the low-delay-requirement MPEG-4/AVC standard, the amount of data transferred between the encoder LSI (of the above-mentioned video compression coding apparatus) and the external memory increases considerably, requiring an extremely large bandwidth for data transfer.

Therefore, an object of the present invention is to be able to reduce the bandwidth required for data transfers carried out between the encoder LSI and the external memory in a video compression coding apparatus taking into account applicability to high-resolution applications that use the low-delay-requirement MPEG-4/AVC standard.

A video compression coding apparatus according to a first aspect of the present invention is one that compresses the amount of information in an input image frame by carrying out a predetermined coding process on the above-mentioned image frame, and comprises an inter-prediction luminance image frame generator that generates, from the input image frame, an inter-prediction luminance image frame by carrying out an inter-prediction process related to the luminance for the image frame (refers to an “inter-image frame prediction process” here and below); a first delay unit that is input with the inter-prediction luminance image frame generated in the above-mentioned inter-prediction luminance image frame generator, and outputs the above-mentioned inter-prediction luminance image frame after the elapse of a predetermined time period; and a second delay unit that is input with the above-mentioned input image frame, and outputs the above-mentioned input image frame after the elapse of a predetermined time period.

In the preferred embodiment related to the first aspect of the present invention, the above-mentioned predetermined time period is either the time required from the above-mentioned inter-prediction luminance image frame being input to the above-mentioned first delay unit until a quantization process related to the above-mentioned input image frame becomes possible, or the time required from the above-mentioned input image frame being input to the above-mentioned second delay unit until a quantization process related to this image frame becomes possible.

In an embodiment that differs from the one mentioned above, the above-mentioned predetermined time period is set longer than the time required for at least three macroblocks worth of the above-mentioned image frame to be input.

In an embodiment that differs from those mentioned above, the above-mentioned quantization process is carried out using a quantization parameter that is determined on the basis of index data calculated for predicting the code quantity subsequent to a coding process for the above-mentioned input image frame.

An embodiment that differs from those mentioned above, further comprising an inter-prediction chrominance image frame generator that generates, from the input image frame, an inter-prediction chrominance image frame by carrying out an inter-prediction process related to chrominance.

In an embodiment that differs from those mentioned above, the above-mentioned first delay unit is an external memory capable of storing the above-mentioned inter-prediction luminance image frame.

In an embodiment that differs from those mentioned above, the above-mentioned second delay unit is an external memory capable of storing the above-mentioned input image frame.

In an embodiment that differs from those mentioned above, the above-mentioned first delay unit is an external memory capable of storing the above-mentioned inter-prediction luminance image frame, and the above-mentioned second delay unit is an external memory capable of storing the above-mentioned input image frame.

Yet another embodiment that differs from those mentioned above further comprises a prediction residual generator that is provided on the input side of the above-mentioned first delay unit and that generates a prediction residual between the above-mentioned input image frame and the above-mentioned inter-prediction luminance image frame, and an inter-prediction luminance image frame regenerator that is provided on the output side of the above-mentioned first delay unit and that regenerates the above-mentioned inter-prediction luminance image frame from the above-mentioned prediction residual and the above-mentioned input image frame.

A video compression coding method according to a second aspect of the present invention for a video compression coding apparatus that compresses the amount of information in an input image frame by carrying out a predetermined coding process on the above-mentioned image frame comprises a first step of generating, from the input image frame, an inter-prediction luminance image frame by carrying out an inter-prediction process related to the luminance for the image frame; a second step of inputting to a first delay unit the inter-prediction luminance image frame generated in the above-mentioned first step, and outputting the above-mentioned inter-prediction luminance image frame from the first delay unit after the elapse of a predetermined time period; and a third step of inputting to a second delay unit the above-mentioned input image frame, and outputting the above-mentioned input image frame from the second delay unit after the elapse of a predetermined time period.

According to the present invention, a video compression coding apparatus is able to reduce the bandwidth required for data transfers carried out between the encoder LSI and the external memory taking into account applicability to high-resolution applications that use the low-delay-requirement MPEG-4/AVC standard.

### BRIEF DESCRIPTION OF THE DRAWINGS

FIG. 1 is a functional block diagram showing the configuration of an ordinary video compression coding apparatus;

FIG. 2 is a functional block diagram showing the overall configuration of a video compression coding apparatus related to a first embodiment of the present invention;

FIG. 3 is a functional block diagram showing the internal configuration of the video compression coding apparatus described in FIG. 2;

FIG. 4 is a functional block diagram showing the overall configuration of a video compression coding apparatus related to a second embodiment of the present invention;

FIG. 5 is a functional block diagram showing the internal configuration of the video compression coding apparatus described in FIG. 4;

FIG. 6 is a functional block diagram showing the overall configuration of a video compression coding apparatus related to a third embodiment of the present invention;

FIG. 7 is a functional block diagram showing the internal configuration of the video compression coding apparatus described in FIG. 6;

FIG. 8 is a functional block diagram showing the overall configuration of a video compression coding apparatus related to a fourth embodiment of the present invention;

FIG. 9 is a functional block diagram showing the internal configuration of the video compression coding apparatus described in FIG. 8;

FIG. 10 is a functional block diagram showing the overall configuration of a video compression coding apparatus related to a fifth embodiment of the present invention; and

FIG. 11 is a functional block diagram showing the internal configuration of the video compression coding apparatus described in FIG. 10.

### DETAILED DESCRIPTION

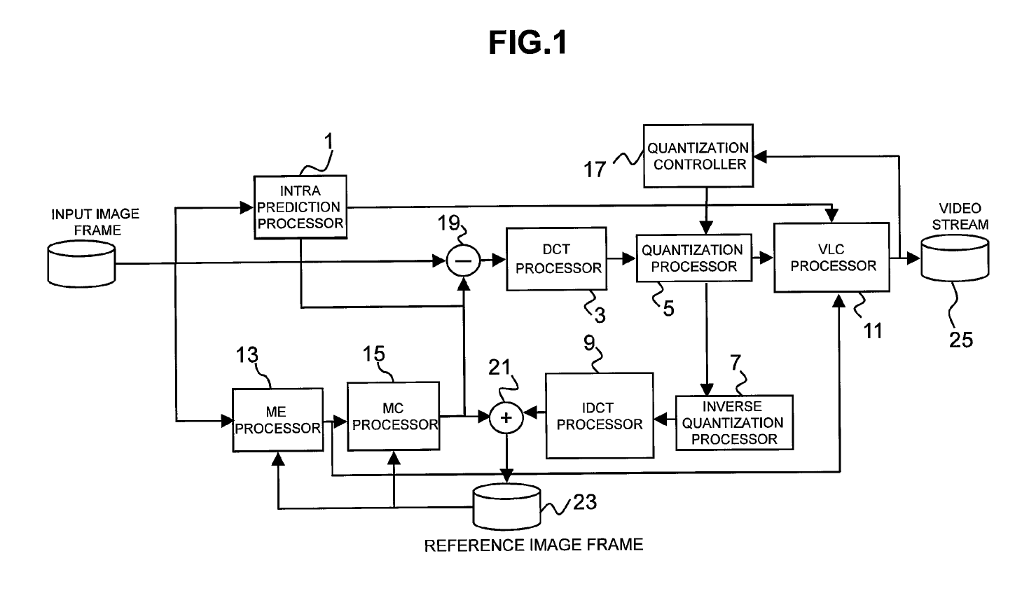

FIG. 1 is a functional block diagram showing the configuration of an ordinary video compression coding apparatus.

In the video compression coding apparatus shown in FIG. 1, a coding process, which is a process for transforming an image frame input to this apparatus (hereinafter, described as the “input image frame”) to a video stream having less data, is carried out using an MPEG scheme. Then, in the coding process in accordance with the MPEG scheme (that is, the MPEG coding process), two types of prediction schemes, i.e. intra prediction (prediction within an image frame) and inter prediction (prediction between image frames), are used. In a coding process that uses the intra prediction scheme, an intra prediction processor 1-based intra prediction process; a DCT (discrete cosine transform) processor 3-based DCT process; a quantization processor 5-based quantization process; an inverse quantization processor 7-based inverse quantization process; an IDCT (inverse discrete cosine transform) processor 9-based IDCT process; and a VLC (variable-length coding) processor 11-based variable length coding process are respectively carried out for a current input image frame. Consequently, a video stream is generated.

Alternatively, in a coding process that uses the inter prediction scheme, a ME (motion estimation) processor 13-based ME process; a MC (motion compensation) processor 15-based MC process; a DCT processor 3-based DCT process; a quantization processor 5-based quantization process; an inverse quantization processor 7-based inverse quantization process; an IDCT processor 9-based IDCT process; and a VLC processor 11-based VLC process are respectively carried out for a current input image frame. Consequently, a video stream is generated. Furthermore, a quantization parameter is determined by a quantization controller 17 on the basis of the amount of video stream output generated by the VLC process in accordance with the VLC processor 11.

In the above-mentioned video compression coding apparatus, the intra prediction processor 1 generates from the current input image frame intra prediction information and a prediction image frame for predicting an image frame that could be input temporally subsequent to the current input image frame. The intra prediction information is output from the intra prediction processor 1 to the VLC processor 11, and the prediction image frame is output from the intra prediction processor 1 to a subtractor 19, respectively. The subtractor 19 calculates the difference, that is, the prediction residual, between the prediction image data (prediction image frame) output from the intra prediction processor 1 and the above-mentioned input image data (input image frame). This calculated prediction residual is output from the subtractor 19 to the DCT processor 3. The DCT processor 3 generates a frequency component by carrying out a DCT process based on the prediction residual output from the subtractor 19. This generated frequency component is output from the DCT processor 3 to the quantization processor 5.

The quantization processor 5 respectively is input with the frequency component output from the DCT processor 3 and the quantization parameter determined by the quantization controller 17. Then, based on this quantization parameter, the quantization processor 5 quantizes the above-mentioned frequency component to reduce the amount of information. The above-mentioned post-quantized frequency component is respectively output from the quantization processor 5 to the VLC processor 11 and the inverse quantization processor 7. The inverse quantization processor 7 is input with the post-quantized frequency component output from the quantization processor 5, and restores the above-mentioned frequency component by carrying out an inverse quantization process relative to this post-quantized frequency component.

The IDCT processor 9 is input with the restored frequency component output from the inverse quantization processor 7. Then, the IDCT processor 9 restores the prediction residual calculated by the subtractor 19 by carrying out an inverse orthogonal process relative to this reduced frequency component. This reduced prediction residual is output from the IDCT processor 9 to an adder 21. The adder 21 respectively is input with the above-mentioned reduced prediction residual output from the IDCT processor 9 and the prediction image data (prediction image frame) generated by the MC processor 15. Then, the adder 21 generates reference image data (a reference image frame) in accordance with adding the above-mentioned reduced prediction residual to the above-mentioned prediction image data (prediction image frame). This generated reference image data (reference image frame) is stored in a storage unit 23 by the adder 21.

The ME processor 13 respectively is input with the current input image frame and the reference image frame stored in the storage unit 23 (an input image frame temporally subsequent to the current input image frame, which is predicted based on an input image frame temporally prior to the current input image frame and the current input image frame). Then, the ME processor 13 generates a motion vector that reveals the location of regions that are similar to respective regions inside the above-mentioned reference image frame and inside the current input image frame by searching these similar regions. This motion vector is respectively output from the ME processor 13 to the MC processor 15 and the VLC processor 11. The MC processor 15 is input with the motion vector output from the ME processor 13. Then, the MC processor 15 references the corresponding reference image frame inside the storage unit 23 on the bases of the location indicated by this motion vector, and generates a prediction image frame by carrying out a filtering process relative to this reference image frame. This generated prediction image frame is respectively output from the MC processor 15 to the subtractor 19 and adder 21.

The VLC processor 11 respectively is input with intra prediction information output from the intra prediction processor 1, the post-quantized frequency component output from the quantization processor 5, and the motion vector output from the ME processor 13. Then, the VLC processor 11 encodes the above-mentioned intra prediction information, the above-mentioned post-quantized frequency component, and the above-mentioned motion vector into a data string having less data. This encoded data string is stored as a video stream in a storage unit 25 by the VLC processor 11.

The MPEG and other such techniques described hereinabove are able to greatly reduce the amount of data possessed by image information while maintaining high image quality, and are therefore being put to use in a wide range of fields, such as (image information) storage media, broadcasting, and communications, and, for example, and an MPEG scheme is also being used in two-way data communication applications that utilize image information, such as videophones. However, two-way data communication applications require coding apparatus with different characteristics than those for storage media or broadcasting due to the high image information quality, high image information compressibility, and low image information transmission delay capabilities demanded by such two-way data communication applications.

The embodiments of the present invention will be explained below in accordance with the drawings.

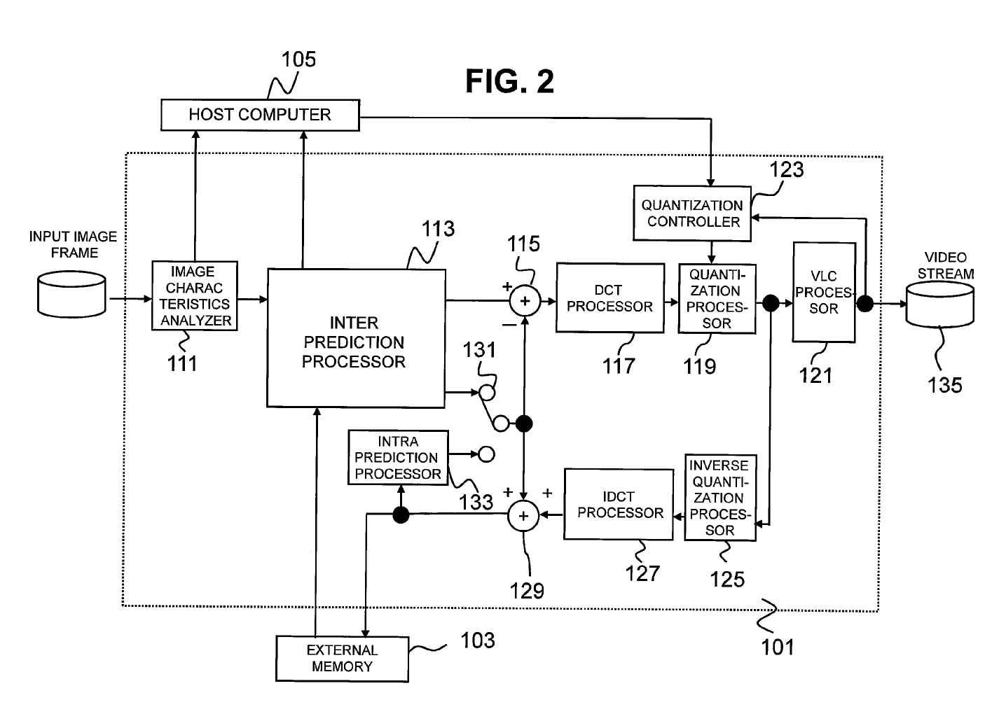

FIG. 2 is a functional block diagram showing the overall configuration of a video compression coding apparatus related to a first embodiment of the present invention.

The above-mentioned video compression coding apparatus, as shown in FIG. 2, comprises an encoder LSI 101, an external memory 103 and a host computer 105. The encoder LSI 101 is for executing a video compression coding process. The encoder LSI 101 comprises various functions respectively denoted by the functional blocks of an image characteristics analyzer 111; an inter prediction processor 113; a first adder 115; an DCT processor 117; a quantization processor 119; a VLC processor 121; a quantization controller 123; an inverse quantization processor 125; an IDCT processor 127; a second adder 129; a prediction selection circuit 131; and an intra prediction processor 133. The above-mentioned functional blocks will be explained in detail further below.

The external memory 103 is disposed externally of the encoder LSI 101 for storing image information (of an image frame), which must be maintained during the steps of the video compression coding process executed by the encoder LSI 101. The external memory 103 is also called a frame memory. The host computer 105 is configured to output to the quantization controller 123 (of the encoder LSI 101) an index for determining a quantization parameter based on index data statistics such as the activity (evaluation values) calculated by the image characteristics analyzer 111 (of the encoder LSI 101) and the SAD (Sum of Absolute Difference) calculated by the inter prediction processor 113 (of the encoder LSI 101). In this embodiment, the host computer 105 exists independently of the encoder LSI 101, but may also be incorporated inside the encoder LSI 101.

In the encoder LSI 101, the image characteristics analyzer 111 analyzes the spatial correlation characteristics of the above-mentioned input image frame so as to estimate the amount of code generated at the time the image frame input to the encoder LSI 101 (input image frame) was compressed. The image characteristics analyzer 111, for example, calculates an evaluation value (activity) related to the complexity of a pattern such as the flatness and intra-AC of the input image frame as disclosed in Japanese Patent Application Laid-open No. 2006-136010. This calculated evaluation value is output from the image characteristics analyzer 111 to the host computer 105. The image characteristics analyzer 111 also outputs the above-mentioned input image frame to the inter prediction processor 113.

The inter prediction processor 113 respectively is input with the above-mentioned input image frame output from the image characteristics analyzer 111 and the image information (of the image frame) output from the external memory 103. Then, the inter prediction processor 113 carries out a motion estimation process and a MC process for a dynamic image inside the above-mentioned input image frame. The inter-image prediction processor 113 respectively outputs the above-mentioned input image frame, the output of which has been delayed, to the first adder 115 for prediction residual generation processing, and the output-delayed prediction image frame, which was obtained in accordance with the inter prediction process, to the prediction selection circuit 131. The inter prediction processor 113 also outputs the SAD (Sum of Absolute Difference) calculated in the above-mentioned motion estimation process to the host computer 105. The configuration of the inter prediction processor 113 will be described in detail further below.

The prediction selection circuit 131 respectively receives the output of the above-mentioned output-delayed prediction image frame output from the inter prediction processor 113 and the output of the prediction image frame output from the intra prediction processor 133. Then, the prediction selection circuit 131 selects, from among the above-mentioned two prediction image frames, the prediction image frame related to the prediction method determined to be the best, and respectively outputs this selected prediction image frame to either the first adder 115 (for carrying out a prediction residual generation process) or the second adder 129.

The first adder 115 calculates the difference, that is, the prediction residual, between the prediction image frame output from the inter prediction processor 113 and the prediction image frame (the prediction image frame output from the inter prediction processor 113) output from the prediction selection circuit 131. This calculated prediction residual is output from the first adder 115 to the DCT processor 117. The DCT processor 117 generates a frequency component by carrying out a DCT process based on the prediction residual output from the first adder 115 the same as the DCT processor 3 shown in FIG. 1. This generated frequency component is output from the DCT processor 117 to the quantization processor 119.

The quantization processor 119 respectively is input with the frequency component output from the DCT processor 117 and the quantization parameter determined by the quantization controller 123 the same as the quantization processor 5 shown in FIG. 1. Then, based on this quantization parameter, the quantization processor 119 quantizes the above-mentioned frequency component to reduce the amount of information. The above-mentioned post-quantized frequency component is respectively output from the quantization processor 119 to the VLC processor 121 and the inverse quantization processor 125. The inverse quantization processor 125 is input with the post-quantized frequency component output from the quantization processor 119, and restores the above-mentioned frequency component by carrying out an inverse quantization process relative to this post-quantized frequency component the same as the inverse quantization processor 7 shown in FIG. 1. The above-mentioned restored frequency component is output from the inverse quantization processor 125 to the IDCT processor 127. The IDCT processor 127 is input with the restored frequency component output from the inverse quantization processor 125 the same as the IDCT processor 9 shown in FIG. 1. Then, the IDCT processor 127 restores the prediction residual calculated by the first adder 115 by carrying out an IDCT process relative to this restored frequency component. This restored prediction residual is output from the IDCT processor 127 to the second adder 129.

The second adder 129 is respectively input with the above-mentioned restored prediction residual output from the IDCT processor 127 and the prediction image data (prediction image frame) selectively output from the prediction selection circuit 131. Then, the second adder 129 generates a reference image frame by adding the above-mentioned restored prediction residual to the above-mentioned prediction image frame. The above-mentioned generated reference image frame is respectively output to the intra prediction processor 133 and the external memory 103 by the second adder 129. The intra prediction processor 133 generates from the reference image frame output from the second adder 129 intra prediction information and a prediction image frame, that is, an image frame that could be input temporally subsequent to the current input image frame. The above-mentioned prediction image frame is output from the intra prediction processor 133 to the prediction selection circuit 131.

The VLC processor 121 is input with the post-quantized frequency component output from the quantization processor 119, and encodes this post-quantized frequency component into a data string having less data. This encoded data string is not only stored as a video stream in a storage unit 135 by the VLC processor 121, but is also output from the VLC processor 121 to the quantization controller 123.

The quantization controller 123 is input with the video stream (of the above-mentioned encoded data string) output from the VLC processor 121. The quantization controller 123 is also input with an index calculated on the bases of an activity output from the host computer 105 and SAD (Sum of the Absolute Difference) statistical data. Then, using the above-mentioned (encoded data string) video stream output quantity, the above-mentioned activity, and the above-mentioned index, the quantization controller 123 determines a quantization parameter. This quantization parameter is output from the quantization controller 123 to the quantization processor 119.

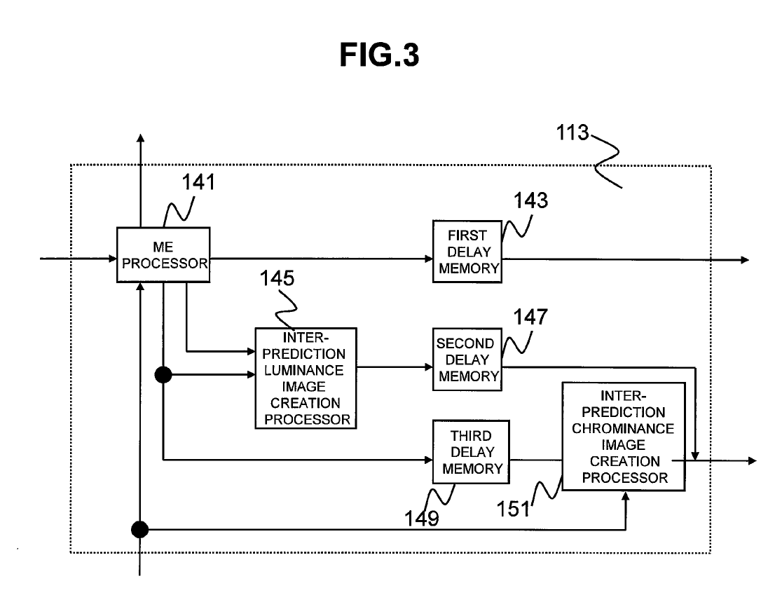

FIG. 3 is a functional block diagram showing the internal configuration of the inter prediction processor 113 described in FIG. 2.

The above-mentioned inter prediction processor 113, as shown in FIG. 3, comprises various functions respectively denoted by the functional blocks of a ME (motion estimation) processor 141; a first delay memory 143; an inter-prediction luminance image creation processor 145; a second delay memory 147; a third delay memory 149; and an inter-prediction chrominance image creation processor 151.

The ME processor 141 is respectively input with an input image frame output in real-time from the image characteristics analyzer 111 shown in FIG. 2, and a reference luminance image frame output from the external memory 103 shown in FIG. 2. Then, the ME processor 141 carries out a block matching operation relative to the above-mentioned reference luminance image frame having SAD (Sum of the Absolute Difference) as the evaluation value for obtaining a motion vector (information) for inter-prediction-based coding. The ME processor 141 also outputs to the host computer 105 the SAD (Sum of the Absolute Difference) and other such evaluation values corresponding to the obtained motion vector (information) for estimating the generation code quantity at the time a compression process is applied to an image frame input using inter-prediction. The ME processor 141 also reads out from the external memory 103 a reference image frame (reference luminance image frame) related to the luminance required to create an inter-prediction image frame, and outputs this reference image frame to the inter-prediction luminance image creation processor 145. The ME processor 141 also respectively outputs the above-mentioned motion vector (information) (obtained by carrying out a block matching operation) to the inter-prediction luminance image creation processor 145 and the third delay memory 149. The ME processor 141 also outputs to the first delay memory 143 an input image frame output in real-time from the image characteristics analyzer 111 (shown in FIG. 2).

The inter-prediction luminance image creation processor 145 is input with the above-mentioned reference image frame (reference luminance image frame) and the above-mentioned motion vector (information) respectively output from the ME processor 141. Then, the inter-prediction luminance image creation processor 145 creates an inter-prediction luminance image frame of fractional pixel precision using a 6-tap filter on the basis of the above-mentioned reference image frame (reference luminance image frame) and the above-mentioned motion vector (information), and stores this inter-prediction luminance image frame in the second delay memory 147.

The first delay memory 143 is input with the input image frame output in real-time from the ME processor 141. Then, a quantization parameter is determined for this input image frame in the quantization controller 123 (shown in FIG. 2), and the first delay memory 143 delays the output of this input image frame to the first adder 115 for carrying out the prediction residual generation process (shown in FIG. 2) (for a predetermined time period) until a quantization process becomes possible for this input image frame (in the quantization processor 119 shown in FIG. 2). Furthermore, the above-mentioned predetermined time period is set at least to the time required for the quantization controller 123 to calculate 1,000 of the above-mentioned statistical data in a case where, for example, the amount of statistical data to be calculated is an image region of 1,000 macroblocks at the time the quantization controller 123 determines the quantization parameter of the above-mentioned input image frame.

The second delay memory 147 is input with an inter-prediction luminance image frame output from the inter-prediction luminance image creation processor 145. Then, a quantization parameter is determined for the above-mentioned input image frame in the quantization controller 123, and the second delay memory 147 delays the output of the above-mentioned inter-prediction luminance image frame to the prediction selection circuit 131 (shown in FIG. 2) (for a predetermined time period) until a quantization process becomes possible for the above-mentioned input image frame in the quantization processor 119.

The third delay memory 149 is input with the above-mentioned motion vector (information) (obtained by carrying out a block matching operation) output from the ME processor 141. Then, a quantization parameter is determined for the above-mentioned input image frame in the quantization controller 123, and the third delay memory 149 delays the output of the above-mentioned motion vector (information) to the inter-prediction chrominance image creation processor 151 (for a predetermined time period) until a quantization process becomes possible for the above-mentioned input image frame in the quantization processor 119. Furthermore, not only is it possible to delay the output of the motion vector (information) with the third delay memory 149, but also by providing an output delay function in the external memory 103 (shown in FIG. 2) as well.

The inter-prediction chrominance image creation processor 151 is input with the above-mentioned motion vector (information) output from the third delay memory 149 after the elapse of the above-mentioned predetermined time period, and reads out from the external memory 103 a reference image frame for chrominance (reference chrominance image frame) on the basis of this motion vector (information). Then, the inter-prediction chrominance image creation processor 151 creates an inter-prediction image frame for chrominance (inter-prediction chrominance image frame). This created inter-prediction chrominance image frame is output from the inter-prediction chrominance image creation processor 151 to the prediction selection circuit 131 (shown in FIG. 2)

As described above, in the inter prediction processor 113 shown in FIG. 3, the process for creating an inter-prediction image frame is separated into a process for creating an inter-prediction luminance image frame in accordance with the inter-prediction luminance image creation processor 145 and a process for creating an inter-prediction chrominance image frame in accordance with the inter-prediction chrominance image creation processor 151, and the inter-prediction luminance image creation processor 145 is arranged in the stage prior to the second delay memory 147. In addition to the above, in the above-mentioned inter prediction processor 113, the inter-prediction chrominance image creation processor 151 is arranged in the stage subsequent to the third delay memory 149. Consequently, the inter prediction processor 113 is able to create an inter-prediction image frame without reading out from the external memory 103 the reference luminance image frame required for creating an inter-prediction luminance image frame, and is also able to output after a predetermined (delay) time the created inter-prediction image frame and the input image frame output in real-time from the image characteristics analyzer 111 (shown in FIG. 2).

For this reason, according to the video compression coding apparatus shown in FIG. 2, rate control based on high-precision code quantity prediction becomes possible without the encoder LSI 101 acquiring from the external memory 103 an inter-prediction luminance image frame that places a heavy load on the bandwidth used in the transfer of data carried out between the encoder LSI 101 and the external memory 103. Consequently, it is possible to greatly reduce the bandwidth used in the transfer of data carried out between the encoder LSI 101 and the external memory 103, making possible the realization of a low-cost, low-power-consumption low delay encoder and enabling the realization of a data communication system that takes the global environment into account for the coming age of two-way data communications.

In the video compression coding apparatus related to the first embodiment of the present invention described hereinabove, using the inter prediction processor 113 of the configuration shown in FIG. 3 makes it possible to greatly reduce the bandwidth required in the transfer of data carried out between the encoder LSI 101 and the external memory 103 compared to the video compression coding apparatus of a configuration like that disclosed in Japanese Patent Application Laid-open No. 2006-136010. However, in the video compression coding apparatus related to the first embodiment, a large memory capacity delay memory (the second delay memory 147) is required inside the inter prediction processor 113. For this reason, there could be cases where realizing a video compression coding apparatus of a configuration like that related to the first embodiment will prove difficult under circumstances in which strict limitations are placed on the size of the hardware (of the video compression coding apparatus).

Accordingly, with the foregoing in view, a video compression coding apparatus related to a second embodiment of the present invention described hereinbelow is configured to make it possible to greatly reduce the bandwidth required in the transfer of data carried out between the encoder LSI and the external memory compared to the video compression coding apparatus related to Japanese Patent Application Laid-open No. 2006-136010 using hardware that is smaller in size than the video compression coding apparatus related to the first embodiment of the present invention.

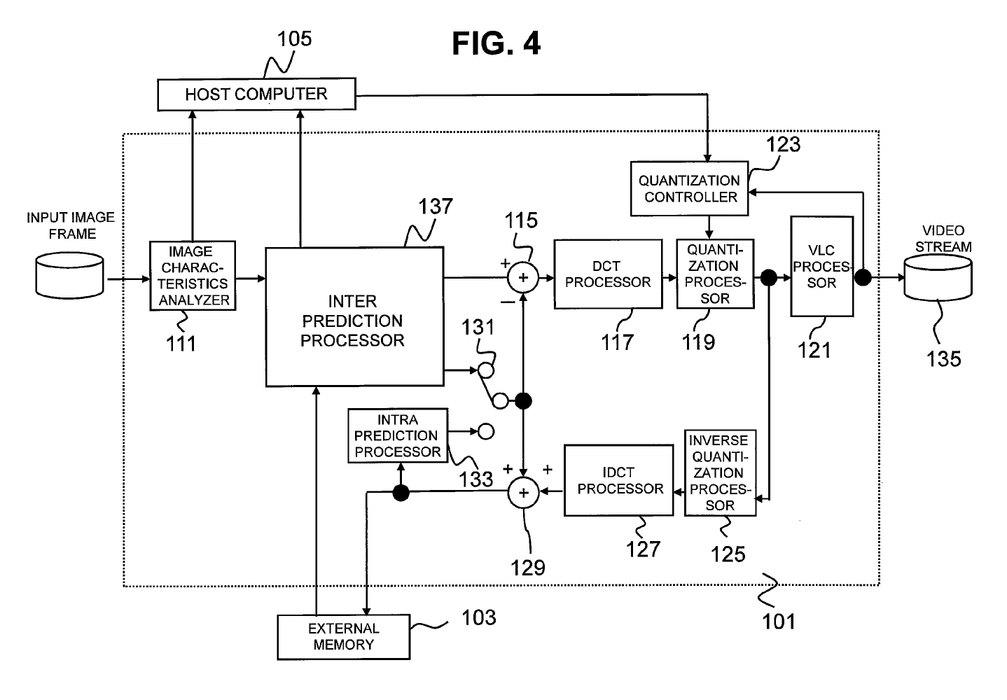

FIG. 4 is a functional block diagram showing the overall configuration of a video compression coding apparatus related to a second embodiment of the present invention. As is clear from comparing FIGS. 2 and 4, the video compression coding apparatus related to the second embodiment of the present invention also comprises an encoder LSI, an external memory, and a host computer the same as the video compression coding apparatus related to the first embodiment of the present invention. The encoder LSI comprises various functions respectively denoted by the functional blocks of an image characteristics analyzer, an inter prediction processor, a first adder, a DCT processor, a quantization processor, a VLC processor, a quantization controller, an inverse quantization processor, an IDCT processor, a second adder, a prediction selection circuit, and an intra prediction processor. However, the internal configuration of the inter prediction processor of the above-mentioned respective parts comprising the encoder LSI differs between the first embodiment of the present invention and the second embodiment of the present invention. Accordingly, in FIG. 4, with the exception of the inter prediction processor, the same reference numerals as those respectively shown in FIG. 2 have been assigned to the respective parts, and a new reference numeral 137 has been assigned only to the inter prediction processor. Therefore, detailed explanations of the respective parts mentioned in FIG. 4 will be omitted.

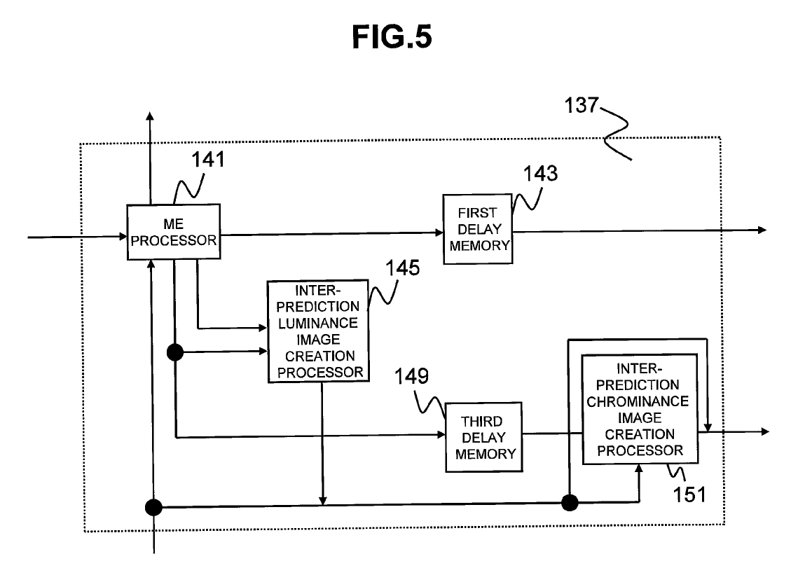

FIG. 5 is a functional block diagram showing the internal configuration of the inter prediction processor 137 disclosed in FIG. 4.

As is clear from comparing FIGS. 3 and 5, the configuration of the above-mentioned inter prediction processor 137 differs from that of the inter prediction processor 113 shown in FIG. 3 primarily in that the second delay memory 147 shown in FIG. 3 is not provided. That is, in the above-mentioned inter prediction processor 137, the inter-prediction luminance image frame created in the inter-prediction luminance image creation processor 145 is delayed a predetermined time period by the external memory 103 before being output. Of the series of processing operations of the above-mentioned inter prediction processor 137, those from the previously described processing operation of the ME processor 141 to the previously described processing operation of the inter-prediction luminance image creation processor 145 are the same as those of the inter prediction processor 113. Accordingly, the same reference numerals have been assigned to those parts in FIG. 5 that are identical to the same parts shown in FIG. 3, and detailed explanations thereof will be omitted.

In FIG. 5, the inter-prediction luminance image frame created in the inter-prediction luminance image creation processor 145 is stored in the external memory 103. Then, in the quantization controller 123 shown in FIG. 4, a quantization parameter related to the input image frame is determined, and, when the predetermined time period until a quantization process becomes possible for the output from the DCT processor 117 has elapsed, the above-mentioned inter-prediction luminance image frame stored in the external memory 103 is read out from the external memory 103 as the delay inter-prediction luminance image frame. This delay inter-prediction luminance image frame is output to the prediction selection circuit 131 shown in FIG. 4.

The processing operations subsequent to those mentioned above for the video compression coding apparatus shown in FIG. 4, which comprises the inter prediction processor 137, are the same as those for the video compression coding apparatus and inter prediction processor 113 related to the first embodiment of the present invention shown in FIGS. 2 and 3, and as such, detailed explanations will be omitted.

As described hereinabove, in the video compression coding apparatus related to the second embodiment of the present invention, since the inter-prediction luminance image frame created in the inter-prediction luminance image creation processor 145 is temporarily stored in the external memory 103 to be output after the elapse of a predetermined time period in the external memory 103, two macroblocks worth of the inter-prediction luminance image frame must be transferred between the encoder LSI 101 and the external memory 103. However, in the video compression coding apparatus related to Japanese Patent Application Laid-open No. 2006-136010, since it is necessary to transfer five macroblocks worth of the inter-prediction luminance image frame between the encoder LSI and the external memory, the video compression coding apparatus related to the second embodiment of the present invention is able to reduce the bandwidth used in the above-mentioned transfer more than the video compression coding apparatus related to Japanese Patent Application Laid-open No. 2006-136010. Furthermore, the transfer of one macroblock worth of an (inter-prediction) luminance image frame is equivalent of transferring approximately 500 Mbits of data per second at full HD (1920×1080) resolution. Comparing the video compression coding apparatus related to the second embodiment of the present invention against the video compression coding apparatus related to the first embodiment of the present invention in terms of hardware size reveals that the former is able to reduce the size of the hardware more than the latter.

As explained hereinabove, according to the second embodiment of the present invention, it is possible to realize a video compression coding apparatus with a smaller hardware size than that of the first embodiment of the present invention. Further, the second embodiment of the present invention also makes it possible to reduce the bandwidth required for the transfer of an (inter-prediction) luminance image frame between the encoder LSI and the external memory much more than in the video compression coding apparatus related to Japanese Patent Application Laid-open No. 2006-136010. Therefore, according to the second embodiment of the present invention, it is possible to greatly reduce the bandwidth required for transferring an (inter-prediction) luminance image frame between the encoder LSI and the external memory, and to realize a low-cost, low-power-consumption video compression coding apparatus (low delay encoder) even in a case where strict limitations are placed on the size of the hardware of the video compression coding apparatus (low delay encoder).

In the video compression coding apparatus related to the second embodiment of the present invention described hereinabove, using the inter prediction processor 137 of the configuration shown in FIG. 5 makes it possible to greatly reduce the bandwidth required in the transfer of data carried out between the encoder LSI and the external memory compared to the video compression coding apparatus related to Japanese Patent Application Laid-open No. 2006-136010 even in a case where strict limitations are placed on the size of the hardware of the video compression coding apparatus. However, in the video compression coding apparatus related to the second embodiment, a large-capacity delay memory (the first delay memory) 143 is required inside the inter prediction processor 137, and as such, there could be cases where realizing the above-mentioned video compression coding apparatus will prove difficult under circumstances in which strict limitations are placed on the size of the hardware of the video compression coding apparatus.

Accordingly, with the foregoing in view, a video compression coding apparatus related to a third embodiment of the present invention described hereinbelow is configured to make it possible to greatly reduce the bandwidth required in the transfer of data carried out between the encoder LSI and the external memory compared to the video compression coding apparatus related to Japanese Patent Application Laid-open No. 2006-136010 using hardware that is smaller in size than the video compression coding apparatus related to the second embodiment of the present invention.

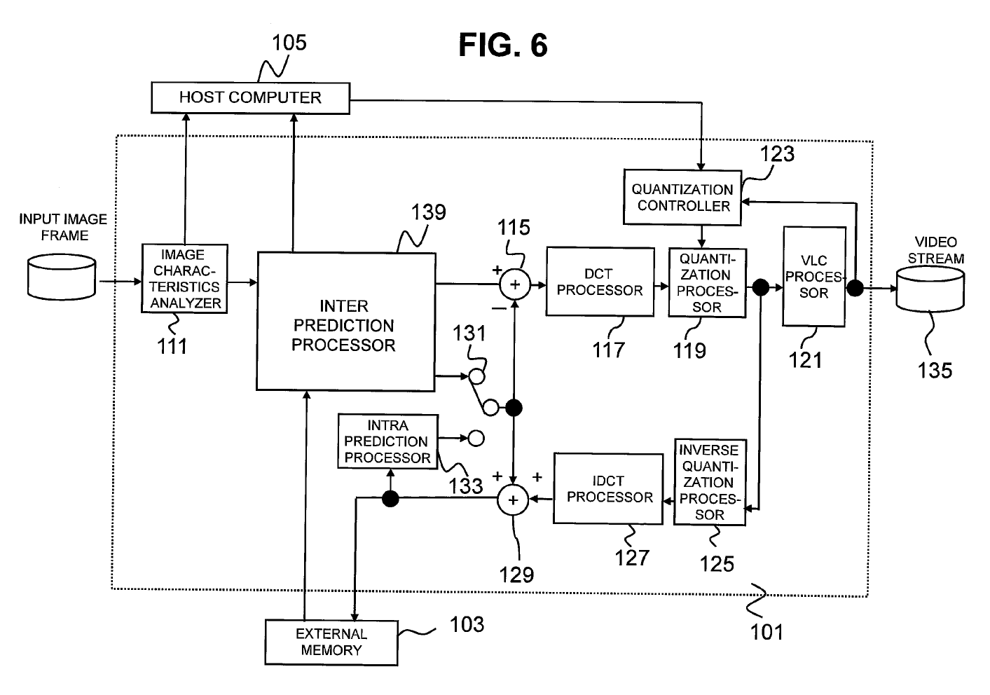

FIG. 6 is a functional block diagram showing the overall configuration of a video compression coding apparatus related to a third embodiment of the present invention.

As is clear from comparing FIGS. 2 and 6, the video compression coding apparatus related to a third embodiment of the present invention also comprises an encoder LSI, an external memory, and a host computer the same as the video compression coding apparatus related to the first embodiment of the present invention. The encoder LSI comprises various functions respectively denoted by the functional blocks of an image characteristics analyzer, an inter prediction processor, a first adder, a DCT processor, a quantization processor, a VLC processor, a quantization controller, an inverse quantization processor, an IDCT processor, a second adder, a prediction selection circuit, and an intra prediction processor. However, the internal configuration of the inter prediction processor of the above-mentioned respective parts comprising the encoder LSI differs between the first embodiment of the present invention and the third embodiment of the present invention. Accordingly, in FIG. 6, with the exception of the inter prediction processor, the same reference numerals as those respectively shown in FIG. 2 have been assigned to the respective parts, and a new reference numeral 139 has been assigned only to the inter prediction processor. Therefore, detailed explanations of the respective parts mentioned in FIG. 6 will be omitted.

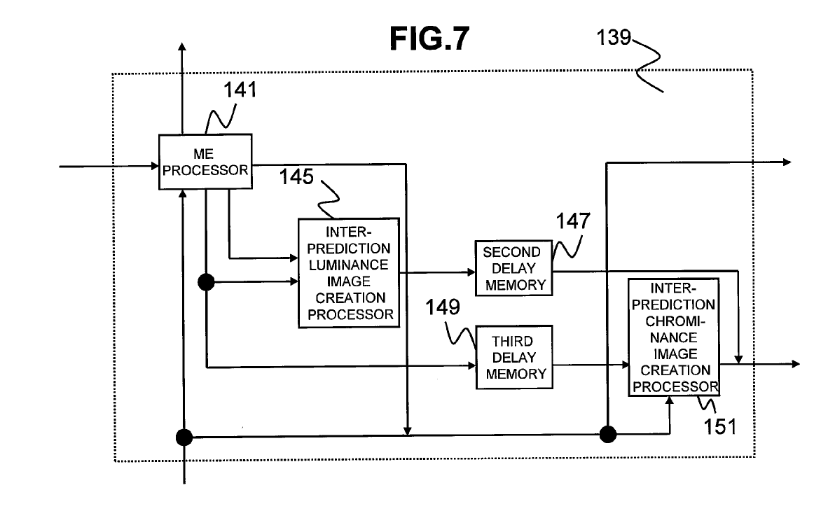

FIG. 7 is a functional block diagram showing the internal configuration of the inter prediction processor 139 disclosed in FIG. 6.

As is clear from comparing FIGS. 3 and 7, the configuration of the above-mentioned inter prediction processor 139 differs from that of the inter prediction processor 113 shown in FIG. 3 primarily in that the first delay memory 143 shown in FIG. 3 is not provided. That is, in the above-mentioned inter prediction processor 139, the input image frame output from the ME processor 141 is delayed a predetermined time period by the external memory 103 before being output. Of the series of processing operations of the above-mentioned inter prediction processor 139, the previously described processing operation of the ME processor 141 is the same as that of the inter prediction processor 113. Accordingly, the same reference numerals have been assigned to those parts in FIG. 7 that are identical to the parts shown in FIG. 3, and detailed explanations thereof will be omitted.

In FIG. 7, the input image frame output from the ME processor 141 is stored in the external memory 103. Then, in the quantization controller 123 shown in FIG. 6, a quantization parameter related to the input image frame is determined, and, when the predetermined time period until a quantization process becomes possible for the output from the DCT processor 117 has elapsed, the above-mentioned input image frame stored in the external memory 103 is read out from the external memory 103 as the delay input image frame. This delay input image frame is output to the first adder 115 that carries out the prediction residual generation process shown in FIG. 6.

The processing operations subsequent to those mentioned above for the video compression coding apparatus shown in FIG. 6, which comprises the inter prediction processor 139, are the same as those for the video compression coding apparatus and inter prediction processor 113 related to the first embodiment of the present invention shown in FIGS. 2 and 3, and as such, detailed explanations will be omitted.

As described hereinabove, in the video compression coding apparatus related to the third embodiment of the present invention, since the input image frame output form the ME processor 141 is temporarily stored in the external memory 103 to be output after the elapse of a predetermined time period in the external memory 103, three macroblocks worth of the inter-prediction luminance image frame must be transferred between the encoder LSI 101 and the external memory 103. However, in the video compression coding apparatus related to Japanese Patent Application Laid-open No. 2006-136010, since it is necessary to transfer five macroblocks worth of the inter-prediction luminance image frame between the encoder LSI and the external memory, the video compression coding apparatus related to the third embodiment of the present invention is able to reduce the bandwidth utilized in the above-mentioned transfer.

Comparing the size of the hardware, since the input image frame has luminance and chrominance, the memory capacity of the first delay memory 143 for delaying the output of the input image frame is larger than the memory capacity of the second delay memory 147 for delaying the output of the luminance (data). Accordingly, comparing the video compression coding apparatus related to the third embodiment of the present invention against the video compression coding apparatus related to the second embodiment of the present invention reveals that the former is able to reduce the size of the hardware more than the latter.

As explained hereinabove, according to the third embodiment of the present invention, it is possible to realize a video compression coding apparatus with a smaller hardware size than that of the second embodiment of the present invention. Further, the third embodiment of the present invention also makes it possible to reduce the bandwidth required for the transfer of an (inter-prediction) luminance image frame between the encoder LSI and the external memory much more than in the video compression coding apparatus related to Japanese Patent Application Laid-open No. 2006-136010. Therefore, according to the third embodiment of the present invention, it is possible to greatly reduce the bandwidth required for transferring an (inter-prediction) luminance image frame between the encoder LSI and the external memory, and to realize a low-cost, low-power-consumption video compression coding apparatus (low delay encoder) even in a case where strict limitations are placed on the size of the hardware of the video compression coding apparatus (low delay encoder).

In the video compression coding apparatus related to the third embodiment of the present invention described hereinabove, using the inter prediction processor 139 of the configuration shown in FIG. 7 makes it possible to reduce the bandwidth required in the transfer of an (inter-prediction) luminance image frame between the encoder LSI and the external memory much more than in the video compression coding apparatus related to Japanese Patent Application Laid-open No. 2006-136010 even in a case where strict limitations are placed on the size of the hardware of the video compression coding apparatus. However, in the video compression coding apparatus related to the third embodiment, a large-capacity delay memory (the second delay memory) 147 is required inside the inter prediction processor 139, and as such, there could be cases where realizing the above-mentioned video compression coding apparatus will prove difficult under circumstances in which strict limitations are placed on the size of the hardware of the video compression coding apparatus.

Accordingly, with the foregoing in view, a video compression coding apparatus related to a fourth embodiment of the present invention described hereinbelow is configured to make it possible to greatly reduce the bandwidth required in the transfer of data carried out between the encoder LSI and the external memory compared to the video compression coding apparatus related to Japanese Patent Application Laid-open No. 2006-136010 using hardware that is even smaller in size than that of the video compression coding apparatus related to the third embodiment.

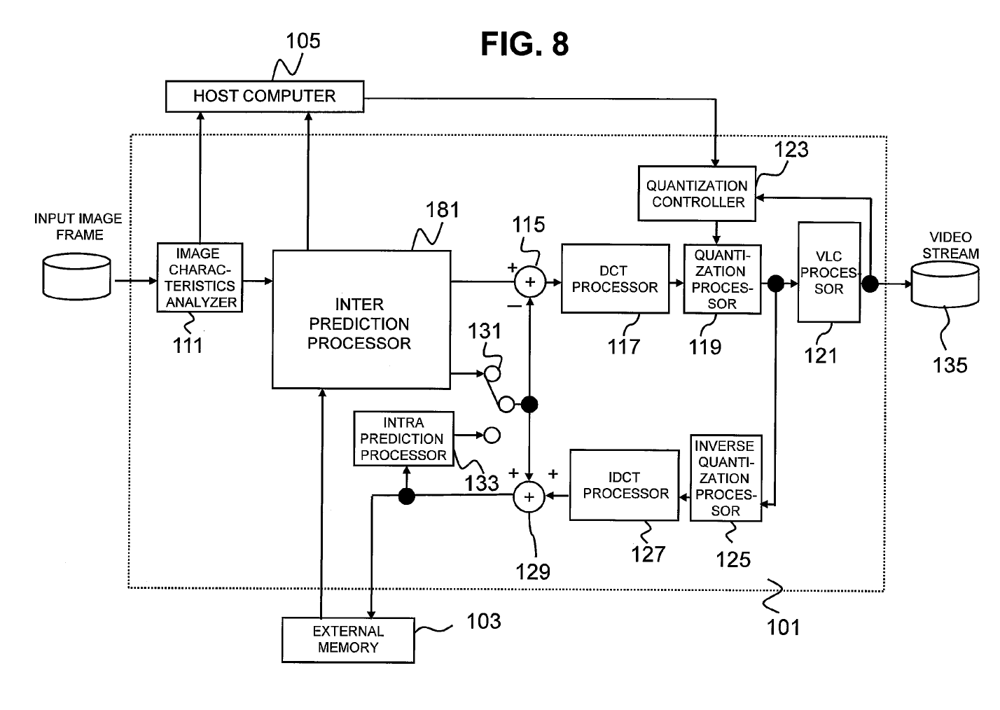

FIG. 8 is a functional block diagram showing the overall configuration of a video compression coding apparatus related to a fourth embodiment of the present invention.

As is clear from comparing FIGS. 2 and 8, the video compression coding apparatus related to a fourth embodiment of the present invention also comprises an encoder LSI, an external memory, and a host computer the same as the video compression coding apparatus related to the first embodiment of the present invention. The encoder LSI comprises various functions respectively denoted by the functional blocks of an image characteristics analyzer, an inter prediction processor, a first adder, a DCT processor, a quantization processor, a VLC processor, a quantization controller, an inverse quantization processor, an IDCT processor, a second adder, a prediction selection circuit, and an intra prediction processor. However, the internal configuration of the inter prediction processor of the above-mentioned respective parts comprising the encoder LSI differs between the first embodiment of the present invention and the fourth embodiment of the present invention. Accordingly, in FIG. 8, with the exception of the inter prediction processor, the same reference numerals as those respectively shown in FIG. 2 have been assigned to the respective parts, and a new reference numeral 181 has been assigned only to the inter prediction processor. Therefore, detailed explanations of the respective parts mentioned in FIG. 8 will be omitted.

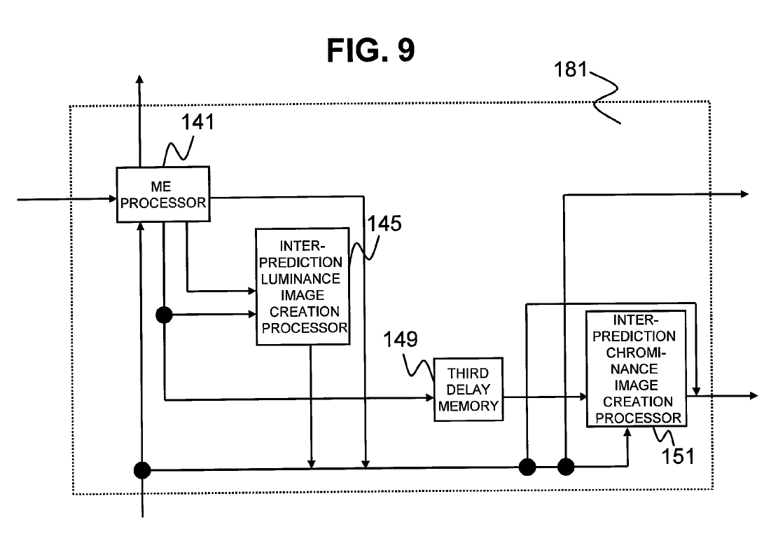

FIG. 9 is a functional block diagram showing the internal configuration of the inter prediction processor disclosed in FIG. 8.

As is clear from comparing FIGS. 3 and 9, the configuration of the above-mentioned inter prediction processor 181 differs from that of the inter prediction processor 113 shown in FIG. 3 primarily in that the first delay memory 143 and the second delay memory 147 shown in FIG. 3 are not provided. That is, in the above-mentioned inter prediction processor 181, the input image frame output from the ME processor 141 and the inter-prediction luminance image frame created in the inter-prediction luminance image creation processor 145 are delayed a predetermined time period by the external memory 103 before being output. Of the series of processing operations of the above-mentioned inter prediction processor 181, the previously described processing operation of the ME processor 141 and the previously described processing operation of the inter-prediction luminance image creation processor 145 are the same as those of the inter prediction processor 113. Accordingly, the same reference numerals have been assigned to those parts in FIG. 9 that are identical to the parts shown in FIG. 3, and detailed explanations thereof will be omitted.

In FIG. 9, the input image frame output from the ME processor 141 is stored in the external memory 103. Then, in the quantization controller 123 shown in FIG. 8, a quantization parameter related to the image frame input into the video compression coding apparatus is determined, and, when the predetermined time period until a quantization process becomes possible for the output from the DCT processor 117 has elapsed, the above-mentioned input image frame stored in the external memory 103 is read out from the external memory 103 as the delay input image frame. This delay input image frame is output to the first adder 115 that carries out the prediction residual generation process shown in FIG. 6. Also, when the above-mentioned series of processing operations by the ME processor 141 have ended, the inter-prediction luminance image creation processor 145 creates an inter-prediction luminance image frame, and stores this created inter-prediction luminance image frame in the external memory 103. Then, in the quantization controller 123 shown in FIG. 8, a quantization parameter related to the input image frame is determined, and, when the predetermined time period until a quantization process becomes possible for the output from the DCT processor 117 has elapsed, the above-mentioned inter-prediction luminance image frame stored in the external memory 103 is read out from the external memory 103 as the delay inter-prediction luminance image frame. This delay inter-prediction luminance image frame is output to the prediction selection circuit 131 shown in FIG. 8.

The processing operations subsequent to those mentioned above for the video compression coding apparatus shown in FIG. 8, which comprises the inter prediction processor 181, are the same as those for the video compression coding apparatus and inter prediction processor related to the first embodiment of the present invention shown in FIGS. 2 and 3, and as such, detailed explanations will be omitted.

As described hereinabove, in the video compression coding apparatus related to the fourth embodiment of the present invention, the input image frame output from the ME processor 141 and the inter-prediction luminance image frame output from the inter-prediction luminance image creation processor 145 are temporarily stored in the external memory 103 and output after the elapse of a predetermined time period in the external memory 103. For this reason, five macroblocks worth of (an input image frame and an inter-prediction luminance image frame) data must transferred between the encoder LSI 101 and the external memory 103, but the data transfer is able to be carried out with high transfer efficiency. By contrast, in the video compression coding apparatus related to Japanese Patent Application Laid-open No. 2006-136010, five macroblocks worth of an inter-prediction luminance image frame must be transferred between the encoder LSI and the external memory, but since rectangular image data of an arbitrary location must generally be read out from the external memory in order to create an inter-prediction luminance image frame, data transfer efficiency is extremely low. Accordingly, the video compression coding apparatus related to the fourth embodiment of the present invention is able to reduce the bandwidth utilized in the above-mentioned transfer.

Comparing the size of the hardware, it is clear that the encoder LSI related to the fourth embodiment of the present invention may be realized in a smaller hardware size than the encoder LSI related to the third embodiment of the present invention, and may also be realized in a smaller hardware size than the encoder LSI related to Japanese Patent Application Laid-open No. 2006-136010. Since the fourth embodiment of the present invention is characterized in that the output of the principal data of the input image frame and inter-prediction luminance image frame to be delayed before being output is delayed by temporarily storing this data in an extremely high-capacity external memory, it is possible to set the image region for calculating the index utilized in determining a quantization parameter to an arbitrary size, making possible even higher precision code control.

As explained hereinabove, according to the fourth embodiment of the present invention, it is possible to realize a video compression coding apparatus with a smaller hardware size than the third embodiment of the present invention. It is also possible to greatly reduce the bandwidth required to transfer an (inter-prediction) luminance image frame between the encoder LSI and the external memory more than in the video compression coding apparatus related to Japanese Patent Application Laid-open No. 2006-136010. Therefore, according to the fourth embodiment of the present invention, it is possible to greatly reduce the bandwidth required for transferring the data of an input image frame and an (inter-prediction) luminance image frame between the encoder LSI and the external memory, and to realize a low-cost, low-power-consumption video compression coding apparatus (low delay encoder) even in a case where yet stricter limitations are placed on the size of the hardware of the video compression coding apparatus (low delay encoder).

In any of the above-described video compression coding apparatus related to the first embodiment of the present invention through the video compression coding apparatus related to the fourth embodiment of the present invention, it is possible the realize more greatly reduced bandwidth for the transfer of data between the encoder LSI and the external memory than in the video compression coding apparatus related to Japanese Patent Application Laid-open No. 2006-136010 by delaying the output of the inter-prediction luminance image frame. However, since a fundamental characteristic feature of the present invention is that the inter-prediction luminance image frame be created in a prior-stage location than the circuit element for delaying the output of the data, such as the delay memory (first through third) and the external memory, the data for which output is delayed by the above-mentioned circuit element is not limited to the inter-prediction luminance image frame. It is possible to delay the output of all data related to luminance from subsequent to an inter-prediction luminance image frame being created until a quantization process is carried out by the quantization processor 119 for the frequency component output from the DCT processor 117 by temporarily storing this data.

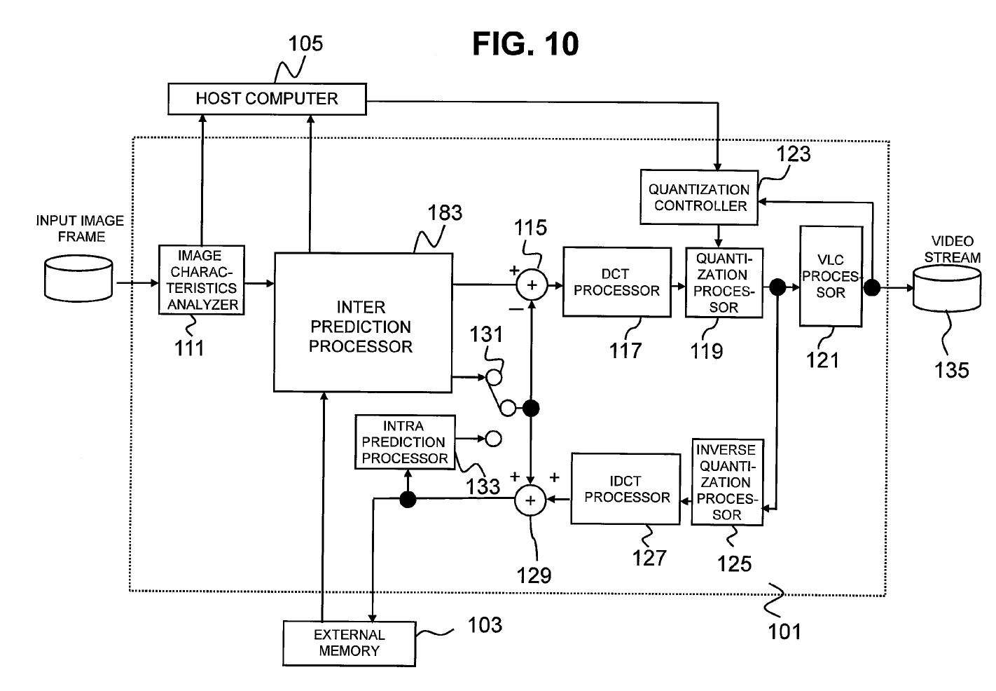

FIG. 10 is a functional block diagram showing the overall configuration of a video compression coding apparatus related to a fifth embodiment of the present invention.

The video compression coding apparatus related to the fifth embodiment of the present invention is primarily for delaying the output of luminance-related data, that is, for example, an inter-prediction luminance image frame.

As is clear from comparing FIGS. 2 and 10, the video compression coding apparatus related to the fifth embodiment of the present invention also comprises an encoder LSI, an external memory, and a host computer the same as the video compression coding apparatus related to the first embodiment of the present invention. The encoder LSI comprises various functions respectively denoted by the functional blocks of an image characteristics analyzer, an inter prediction processor, a first adder, a DCT processor, a quantization processor, a VLC processor, a quantization controller, an inverse quantization processor, an IDCT processor, a second adder, a prediction selection circuit, and an intra prediction processor. However, the internal configuration of the inter prediction processor of the above-mentioned respective parts comprising the encoder LSI differs between the first embodiment of the present invention and the fifth embodiment of the present invention. Accordingly, in FIG. 10, with the exception of the inter prediction processor, the same reference numerals as those respectively shown in FIG. 2 have been assigned to the respective parts, and a new reference numeral 183 has been assigned only to the inter prediction processor. Therefore, detailed explanations of the respective parts mentioned in FIG. 10 will be omitted.

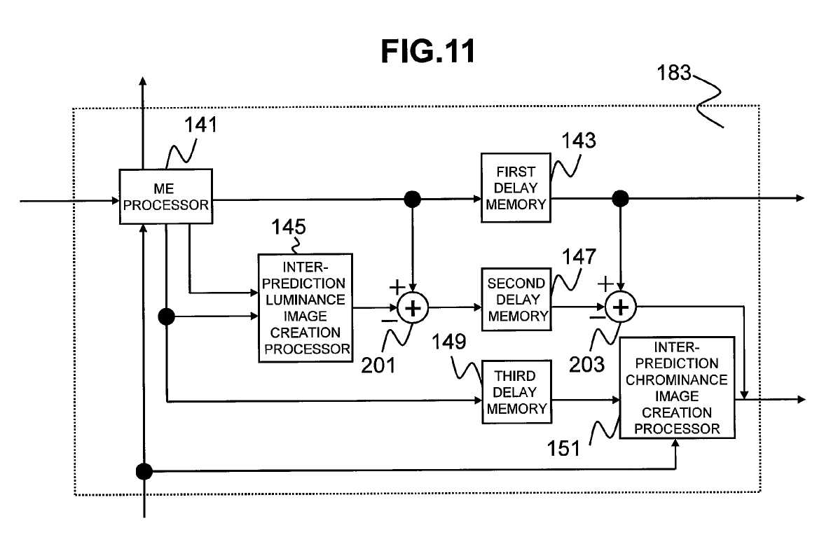

FIG. 11 is a functional block diagram showing the internal configuration of the inter prediction processor 183 disclosed in FIG. 10.

As is clear from comparing FIGS. 3 and 11, the configuration of the above-mentioned inter prediction processor 183 differs from that of the inter prediction processor 113 shown in FIG. 3 in that adders 201, 203 are respectively provided on the input side and the output side of the second delay memory 147. That is, the adder 201 (provided on the input side of the second delay memory 147) is an adder for carrying out a prediction residual generation process (hereinafter described as the “prediction residual generation adder”), and the adder 203 (provided on the output side of the second delay memory 147) is an adder for carrying out a prediction residual re-generation process (hereinafter described as the “prediction residual re-generation adder). Therefore, the output from the prediction residual generation adder 201 is input to the second delay memory 147, and the output from the prediction residual re-generation adder 203 is input to the prediction selection circuit 131 (shown in FIG. 10).

In the above-mentioned inter prediction processor 183, the prediction residual generation adder 201 takes the difference between the input image frame output from the ME processor 141 and the inter-prediction luminance image frame output from the inter-prediction luminance image creation processor 145, generates a prediction residual, and stores this prediction residual in the second delay memory 147. Conversely, the prediction residual re-generation adder 203 takes the difference between the input image frame output from the first delay memory 143 after the elapse of the previously described predetermined time period and the above-mentioned prediction residual output from the second delay memory 147 after the elapse of the previously described predetermined time period, generates a prediction image frame, and outputs this prediction image frame to the prediction selection circuit 131 shown in FIG. 10.

In accordance with providing an inter prediction processor of the above-mentioned configuration, the video compression coding apparatus related to the fifth embodiment of the present invention supports the increased bandwidth for transferring data between the encoder LSI and the external memory of the video compression coding apparatus related to Japanese Patent Application Laid-open No. 2006-136010.

Of the series of processing operations of the above-mentioned inter prediction processor 183, the previously-described processing operations of the ME processor 141 and the previously-described processing operations of the inter-prediction luminance image creation processor 145 are the same as those of the inter prediction processor 113. Accordingly, the same reference numerals have been assigned to those parts in FIG. 11 that are identical to the parts shown in FIG. 3, and detailed explanations thereof will be omitted.

In FIG. 11, the inter-prediction luminance image frame created in the inter-prediction luminance image creation processor 145 is output to the prediction residual generation adder 201. In the prediction residual generation adder 201, as described previously, a prediction residual is created from the input image frame from the ME processor 141 and the inter-prediction luminance image frame from the inter-prediction luminance image creation processor 145, and this prediction residual is stored in the second delay memory 147. Conversely, the input image frame output from the ME processor 141 is stored in the first delay memory 143. Then, a quantization parameter related to this input image frame is determined in the quantization controller 123 shown in FIG. 10, and when the predetermined time period until a quantization process is possible for the output from the DCT processor 117 has elapsed, the above-mentioned prediction residual stored in the second delay memory 147 is output from the second delay memory 147 to the prediction residual re-generation adder 203.

In the prediction residual re-generation adder 203, an inter-prediction luminance image frame that is the same as the one created by inter-prediction luminance image creation processor 145 is created from the above-mentioned prediction residual from the second delay memory 147 and the above-mentioned input image frame from the first delay memory 143. This inter-prediction luminance image frame is output from the prediction residual re-generation adder 203 to the prediction selection circuit 131 (shown in FIG. 10).

The processing operations subsequent to those mentioned above for the video compression coding apparatus shown in FIG. 10, which comprises the inter prediction processor 183, are the same as those for the video compression coding apparatus and inter prediction processor 113 related to the first embodiment of the present invention shown in FIGS. 2 and 3, and as such, detailed explanations will be omitted.

As described hereinabove, in the video compression coding apparatus related to the fifth embodiment of the present invention, a prediction residual (from between the input image frame and the inter-prediction luminance image frame) is generated, this prediction residual is output after the elapse of the predetermined time period, and a processing operation for restoring the inter-prediction luminance image frame is carried out using the prediction residual that delayed this output. However, the processing operations other than this series of processing operations are the same as those of the video compression coding apparatus related to the first embodiment of the present invention. Furthermore, it is also possible to reduce the power consumption required for the operating process in the first adder 115 by making the configuration such that the predict-ion residual (data) output from the second delay memory 147 is directly output to the DCT processor 117 without going through the prediction residual re-generation adder 203 and the first adder 115 (for carrying out a prediction residual generation process) shown in FIG. 10.

In the video compression coding apparatus related to the fifth embodiment of the present invention as well, making a selection that delays the data output of the input image frame and the prediction residual using a memory built into the encoder LSI like the delay memory described hereinabove, or that causes this delay by using a memory that is mounted externally to the encoder LSI like the external memory 103, or that causes this delay by using an appropriate combination of the above-mentioned built-in memory and external memory makes possible a modification like those of the second through the fourth embodiments of the present invention that is also be regarded as a variation of the first embodiment of the present invention. In addition, respectively arranging the DCT processor 117 shown in FIG. 10 on the input side, and the IDCT processor 127 shown in FIG. 10 on the output side of the second delay memory 147 shown in FIG. 11 also makes it possible to use the output-delayed data as a post-DCT process coefficient in the image information luminance.

As explained hereinabove, according to the fifth embodiment of the present invention, rate control based on high-precision code quantity prediction is possible without acquiring from the external memory the inter-prediction luminance image frame, which places a big load on the bandwidth required for transferring data between the encoder LSI and the external memory. Consequently, it is possible to greatly reduce the bandwidth used to transfer data between the encoder LSI 101 and the external memory 103, making possible the realization of a low-cost, low-power-consumption low delay encoder and enabling the realization of a data communication system that takes the global environment into account for the coming age of two-way data communications.

The preferred embodiments of the present invention have been described hereinabove, but these embodiments are example for explaining the present invention, and do not purport to limit the scope of the present invention solely these embodiment. The present invention is able to be put into practice in a variety of other modes.

What is claimed is:

1. A video compression coding apparatus that compresses the amount of information in an input image frame by carrying out a predetermined coding process on the image frame, the video compression coding apparatus comprising:
an inter-prediction luminance image frame generator configured to generate, from the input image frame, an inter-prediction luminance image frame by carrying out an inter-prediction process related to the luminance of the image frame;
a first delay unit configured to be input with the inter-prediction luminance image frame generated in the inter-prediction luminance image frame generator, and to output the inter-prediction luminance image frame after the elapse of a predetermined time period; and
a second delay unit configured to be input with the input image frame, and to output the input image frame after the elapse of a predetermined time period.

2. The video compression coding apparatus according to claim 1, wherein the predetermined time period is either the time required from the inter-prediction luminance image frame being input to the first delay unit until a quantization process related to the input image frame becomes possible, or the time required from the input image frame being input to the second delay unit until a quantization process related to this image frame becomes possible.

3. The video compression coding apparatus according to claim 2, wherein the predetermined time period is set longer than the time required for at least three macroblocks worth of the image frame to be input.

4. The video compression coding apparatus according to claim 2, wherein the quantization process is carried out using a quantization parameter that is determined on the basis of index data calculated for predicting an amount of code subsequent to a coding process for the input image frame.

5. The video compression coding apparatus according to claim 1 further comprising:
an inter-prediction chrominance image frame generator configured to generate, from the input image frame, an inter-prediction chrominance image frame by carrying out an inter-prediction process related to chrominance.

6. The video compression coding apparatus according to claim 1, wherein the first delay unit is an external memory capable of storing the inter-prediction luminance image frame.

7. The video-compression coding apparatus according to claim 1, wherein the second delay unit is an external memory capable of storing the input image frame.

8. The video compression coding apparatus according to claim 1, wherein the first delay unit is an external memory capable of storing the inter-prediction luminance image frame, and the second delay unit is an external memory capable of storing the input image frame.

9. The video compression coding apparatus according to claim 1, further comprising:
a prediction residual generator provided on the input side of the first delay unit and configured to generate a prediction residual between the input image frame and the inter-prediction luminance image frame; and
an inter-prediction luminance image frame regenerator provided on the output side of the first delay unit and configured to regenerate the inter-prediction luminance image frame from the prediction residual and the input image frame.

10. A video compression coding method for a video compression coding apparatus that compresses the amount of information in an input image frame by carrying out a predetermined coding process on the image frame, the video compression coding method comprising:
a first step of generating, from the input image frame, an inter-prediction luminance image frame by carrying out an inter-prediction process related to the luminance for the image frame;
a second step of inputting to a first delay unit the inter-prediction luminance image frame generated in the first step, and outputting the inter-prediction luminance image frame from the first delay unit after the elapse of a predetermined time period; and
a third step of inputting to a second delay unit the input image frame, and outputting the image frame from the second delay unit after the elapse of a predetermined time period.
